(19) United States
(12) Patent Application Publication
(10) Pub. No.: US 2015/0034503 A1
(43) Pub. Date: Feb. 5, 2015

(54) METHOD FOR PRODUCING PACKS AND ASSOCIATED DEVICE

(71) Applicant: Marco Kettwig, Troisdorf (DE)

(72) Inventor: Marco Kettwig, Troisdorf (DE)

(21) Appl. No.: 14/349,044

(22) PCT Filed: Oct. 15, 2012
(86) PCT No.: PCT/EP2012/070396

§ 371 Date: Apr. 1, 2014

(30) Foreign Application Priority Data
Nov. 17, 2011 (DE) 102011055462.9

(51) Int. Cl. B65D 71/06; B32B 37/30; B32B 38/00; B32B 37/02; B32B 37/06

(52) U.S. Cl. CPC B65D 71/06; B32B 37/02; B32B 37/06; B32B 38/0012; B32B 37/30
USPC 206/139; 156/308.2; 156/289; 156/559; 156/443

(57) ABSTRACT

The invention relates to a method for producing packs (1) made of plastics film, having at least one compartment (7a, 7b, 7c, 7d, 7e, 7f), for articles, in particular for containers. According to the invention, two layers (4, 5) made of plastics film which are located one above the other are welded continuously or cyclically with at least one longitudinal weld (8), subsequently at least one further outer layer (3, 6) made of plastics film is placed on the two welded inner layers (4, 5) and is fastened continuously or cyclically to these already welded inner layers (4, 5). Furthermore, the invention relates to a device (15a, 15b) for producing packs (1) made of plastics film, having at least one compartment (7a, 7b, 7c, 7d, 7e, 7f), for articles, in particular for containers. The invention also relates to a pack (1) for articles, in particular for containers. Furthermore, the invention relates to a row of packs.

The invention relates to a method of making packs from plastic film packs and each having at least one compartment for articles, in particular containers. The invention also relates to an apparatus for making from plastic a film pack having at least one compartment for articles, in particular containers. In addition, the invention relates to a pack for articles, in particular containers. Furthermore, the invention relates to a row of packs.

US 2011/0056175 has disclosed a method of packaging products. According to the method, two heat-shrinkable sheets are stepped and joined to each other transversely so that a plurality of openings is formed. The sheets are then each perforated and an article is inserted into each opening. After the sheet is torn along the perforation line, the packs containing the articles are heated, thus producing a pack containing shrink-wrapped articles.

This prior-art method has the disadvantage that it is only possible to produce packs in steps since the sheet layers are welded transversely. Another disadvantage is that using the method requires the use of expensive, complex machines.

The object of the invention, therefore, is to create a method and apparatus by means of which it is possible to easily, inexpensively, and rapidly produce from plastic film packs for articles.

This object is attained in that two inner layers of plastic film resting one on top of the other are welded together continuously or in steps with at least one longitudinal weld and then at least one additional outer layer of plastic film is placed against the two welded-together inner layers and is fastened continuously or in steps to these welded-together inner layers.

The object is also attained in that the apparatus has means for carrying out the method according to one of claims 1 through 27.

It is advantageous that, by welding the films together longitudinally, it is also possible to perform a continuous, i.e. not stepped, welding of the layers of plastic film. As a result, it is also possible to produce packs at a high speed while simultaneously achieving a high level of quality. Also in the production context, longitudinal welding of the layers enables a uniform repeatability of the packs. It is also possible to produce containers in any width and height. In addition, it is possible to produce packs that have from one compartment to an almost limitless number of compartments. Because the packs are rolled longitudinally onto for example one roll such as a takeup roll, it is also advantageously possible to use layers that are of plastic film with a low shrinkage index since when the packs are filled with a product, the packs are guided straight instead of at an inclined angle around the respective products to be packaged. Due to the low shrinkage index, it is also possible that there is a reduction in the weld shrinkage when the layers are shrunk. It is also advantageous that as part of the production of the package, the layers are first printed in the apparatus. In this connection it is also possible for the prior corona pretreatment that is usually required for the printing to be integrated directly into the production process. It is also advantageously possible to use a single film layer or two film layers that are each appropriately folded and/or cut to produce individual layers. Particularly when using a single film layer, which is folded and then cut into several layers to be welded in the apparatus, it is possible to position the respective layers relative to one another with precise pattern repeat matching so that the printed regions rest against one another with precise pattern repeat matching. Because of this supply from a single film layer, it is thus possible to supply the layers produced from this single layer independently with regard to the pattern repeat. The longitudinally welded layers form packs that can be wound onto a takeup roll or the like to form a string of packs. Because of the longitudinal winding, it is possible for a larger number of packs to fit onto a takeup roll than is the case with packs produced transversely. The invention also makes it possible to reduce the machine costs since fewer machine parts are used in the apparatus according to the invention. This also advantageously reduces the production costs for a pack according to the invention as well as for the production method itself.

First, the fastening of at least one outer layer to the two welded-together inner layers by a welding process will be described below as a preferred, advantageous embodiment of the invention:

The outer layer is preferably welded to the welded-together inner layers with at least one longitudinal weld; the two inner layers, which have already been previously welded, are kept apart from each other with the aid of at least one means in order to prevent a welding of the two inner layers.

Preferably, a separating lacquer is used as the means; another preferable option is to use a mechanical separator, in particular an insulating strip.

The inner face of the one inner layer and/or the inner face of the second inner layer gets coated or preferably is coated with separating lacquer. The separating lacquer here prevents the welding of the inner layers in the region in which it is applied to the inner layers when the at least one outer layer is welded to the respective adjacent inner layer.

The insulating strip is preferably inserted between the two inner layers before the two inner layers are welded. The at least one insulating strip inserted between the two inner layers prevents a welding-together of the two inner layers at the respective insulating strip during the welding longitudinally of the at least one outer layer to the respective inner layer.

Preferably, an insulating strip of Teflon is used. It can be formed as a Teflon belt or the like.

The layers to be welded are preferably welded by at least one longitudinal welding bar or by at least one pair of longitudinal welding bars. The longitudinal welding bar or the pair of longitudinal welding bars is preferably continuously heated during the production of the packs. Depending on the kind of layers of plastic film to be welded, for example plastic film layers of polyethylene or the like, the welding heat required to produce a longitudinal weld is produced by a suitable number of longitudinal welding bars or pairs of longitudinal welding bars.

Preferably, pairs of longitudinal welding bars are used to produce packs. Preferably, one, two, three, four, five, or six pairs of longitudinal welding bars are used for the longitudinal welding of the respective specific layers. Preferably, one, two, or three pairs of longitudinal welding bars are used for the welding of the two inner layers and one, two, or three pairs of longitudinal welding bars are respectively also used for the welding of the outer layer to the respective inner layer, for each longitudinal weld that is to be welded. This number of pairs of longitudinal welding bars is used for each longitudinal weld of the packet. For parallel longitudinal welds next to one another, a plurality of pairs of longitudinal welding bars in the preferred number described above are arranged parallel and next to one another so that twice the number of pairs of longitudinal welding bars are used in the apparatus when there are two welds, three times the number of pairs of longitudinal welding bars are used when there are three welds, and so forth.

In a particularly preferred embodiment, the layers are welded in a welding tower in which the longitudinal welding bars are oriented so that the layers to be welded are guided perpendicular to the floor as they pass through the respective pairs of longitudinal welding bars for the welding. The floor is the surface on which an apparatus for making packs and using the production method rests. This floor is horizontal. Alternatively or in addition, it is also possible to weld the at least one outer layer to the respective inner layer by another means, for example by a laser, a welding disk, or the like.

The layers to be welded are preferably welded by the longitudinal welding bar or the pair of longitudinal welding bars in a travel direction perpendicular to the supply direction of the inner layers that are to be welded. An arrangement of the at least one longitudinal welding or the at least one pair of longitudinal welding bars perpendicular to the supply direction of the inner layers to be welded produces a welding tower in which the at least one outer layer is welded to the respective inner layer. The supply direction in this case is parallel to the floor on which the apparatus for making the packs rests and is thus horizontal.

An alternative production method in another advantageous embodiment that uses gluing instead of welding will be described below:

The outer layer is preferably glued to the welded-together inner layers so that the outer layer is fastened to one of the inner layers.

The outer layer is coated with a reactive glue, preferably a hot melt, preferably before the gluing procedure, or the outer layer is preferably coated with a reactive glue, preferably a hot melt.

When the outer layer is fastened to the respective inner layer of the two welded-together inner layers, no further welding procedure is needed if the outer layer has been glued to the two inner layers.

The two production methods (welding and gluing) described above make it possible to produce packs for articles continuously or in steps, i.e. discontinuously, or by a combination of the two, i.e. semi-stepped and semi-continuously; the packs are preferably formed with one or two rows. The packs produced according to the invention are also referred to as containers, chain sleeves, or shrink sleeves.

In a two-row pack, the articles are for example containers in the form of bottles or the like, placed in a pack in a 2×2, 2×3, or 2×4 array or the like. For example, six articles are packed in a 2×3 pack, with each of the articles being packed in a respective one of the six compartments.

In a one-row pack, the articles are placed in the pack in a single row, i.e. in a 1×1, 1×2, or 1×3 array, or the like.

Articles of any size and shape can be packaged in a pack produced according to the invention. It is thus possible, for example, to package a container in a respective compartment of the pack; the container can be round, square, cylindrical, or any other shape. It is thus also possible, for example, to package bulbous embodiments of containers or the like in the respective pack.

The production of a single-row pack will be described in detail below:

Preferably before the outer layer is fastened to the respective inner layer, the two inner layers are each cut at the longitudinal weld of the two inner layers so that these cut inner layers constitute a part of the inner layers. The part of the inner layers has a respective compartment for each of the articles. Preferably, several parts are produced so that the subsequently produced pack has several compartments arranged in a single row.

Preferably before the outer layer is fastened to the respective inner layer, a lateral fold is produced in the cut inner layers, at the cut longitudinal weld of the cut inner layers.

The at least two cut inner layers that each have the respective lateral fold at the longitudinal weld are preferably positioned on a width of the pack that is to be produced, preferably before the outer layer is fastened to the respective inner layer. It is thus possible to arrange these cut inner layers next to one another in a row relative to the width of the pack to be produced in such a way that there are exactly as many of these cut inner layers as there are compartments for the single-row packs.

The cut inner layers are each preopened, preferably before the outer layer is fastened to the respective inner layer. This is necessary to permit the article—which is to be inserted into the respective compartment—to actually be inserted since the shape of the single-row pack is predetermined during the gluing or welding procedure.

In a particularly preferred embodiment, at least two outer layers are welded to at least two inner layers by the method according to the invention. These four layers that rest against one another make it possible to simply and inexpensively produce one-row or two-row packs with any number of compartments. A method of this kind, among other things, is described below:

On the other side of the already welded layers, preferably at least one second outer layer of plastic film is laid onto the welded-together inner layers and the second, additional outer layer is preferably fastened to the second inner layer, in particular is welded or glued to it. It is fastened in a continuous or stepped fashion.

The outer layers are preferably laid in such a way that both of the outer layers are placed before the outer layer is fastened to the respective inner layer.

The production variant in which four layers of plastic film are used to produce a two-row pack is the particularly preferred production method according the invention.

Other preferred and advantageous embodiments of the production method according to the invention will be described in detail below:

At least one handle strip is preferably attached to the pack or at least one handle strip is preferably provided in—in particular punched into—the layers. The handle strip serves as a carrying handle for carrying the pack.

A bidirectionally shrinkable plastic film is used for at least one layer. It is thus possible, by the shrinking of the plastic film, for the articles to be enclosed in the respective compartments in a manner that is secure, but can still be detached by force, thus preventing the articles from falling out of the filled pack.

Preferably, at least one detachment perforation line is provided in—in particular punched into—at least one layer, parallel to the longitudinal weld that is to be welded in the inner layers. Preferably, a detachment perforation line is provided near a compartment of the two-row pack. Particularly preferably, the detachment perforation line is provided in the outer layer near the respective compartment of the two-row pack. In a one-row pack, the detachment perforation line is preferably between the compartments.

A detachment perforation line makes it possible for the pack to tear at the detachment perforation line when one of the articles is removed from the pack so that the article can be easily removed from the compartment or the pack. As a result, the compartment is easy to open.

Alternatively or in addition, it is possible to embody a part of the compartment as a label so that when the article is removed from the compartment, a label remains on the article. This will be described in greater detail below.

At least one pattern repeat perforation line is provided in—in particular punched into—the layers, preferably perpendicular to the longitudinal weld of the inner layers. The pattern repeat perforation line makes it possible for several packs, which have been produced longitudinally and have for example been wound onto a takeup roll or the like, to be easily separated from one another along the pattern repeat perforation line after they are unwound again. The separated packs can then be easily filled with articles.

The pattern repeat perforation line is preferably provided in the layers, spaced apart by a height. This makes it possible for each pack that is separated at a pattern repeat perforation line to already be exactly the size required for packing the respective article.

The inner and outer layers are preferably produced from a single film layer, in particular a folded and/or cut film layer, or the inner layers are preferably produced from one film layer, in particular a folded and/or cut film layer, and the outer layers are preferably produced from another film layer, in particular a folded and/or cut film layer.

The film layer is preferably unwound from a supply roll.

Preferably, a respective part of the outer layer and/or a respective part of the inner layer is or gets formed as a label for the article and when the article is removed from the pack, the label remains on the article.

The shape of the respective labels is preferably produced before the longitudinal welding is performed. It is thus possible to simply apply a reactive glue or the like to the appropriate layer at the label.

The labels are preferably each at the respective compartments.

At the edge of a label, preferably a perforation line or a precut for the removal of the label is provided and the labels are preferably provided with a reactive glue on the side of the respective layer that is turned toward the article. In a precut, the contour of a label is cut out except for a few retaining pieces.

If the label is near a compartment, then when an article is removed from a compartment of a pack, the label can remain stuck to the article in accordance with the above description. In addition, the label tears out ideally along the perforation line or the precut.

An apparatus according to the invention and its preferred advantageous embodiments will be described in detail below. The production method according to the invention can be carried out on the apparatus:

According to the invention, an apparatus for making packs out of plastic film, having at least one compartment for articles, in particular containers, has means for carrying out the method according to one of claims 1 through 27.

In an advantageous embodiment, the apparatus has at least one longitudinal welding bar or at least one pair of longitudinal welding bars. Preferably, the apparatus has one, two, three, four, five, or six pairs of longitudinal welding bars for each longitudinal weld that is to be welded. For longitudinal welds that are to be welded and are next to and parallel to one another, two times, three times, etc. times the necessary number described as a preferred number, in accordance with the number of longitudinal welds that are to be welded parallel to one another. When two longitudinal welds are to be welded parallel to each other, twice the number are used, when three welds are to be welded parallel to one another, three times the number are used, and so forth.

In another advantageous embodiment, the length of a longitudinal welding bar or the length of a longitudinal welding bar of a pair of longitudinal welding bars is between 200 mm and 300 mm, preferably 250 mm. It is also possible to use larger or smaller dimensions for the length of a longitudinal welding bar or the length of a longitudinal welding bar of a pair of longitudinal welding bars if the dimensions of a respective pack are particularly large or particularly small.

Preferably, a Teflon belt extends around the longitudinal welding bar or around the longitudinal welding bar of a pair of longitudinal welding bars. The Teflon belt is preferably formed as a revolving, endless belt and is preferably separately driven. The travel speed of the Teflon belt is preferably less than, equal to, or greater than—preferably equal to—the travel speed of the layers to be welded. By adapting the travel speed with the separate drive unit, it is possible to adjust the weld quality. The seam quality that is produced by the longitudinal weld process is particularly good when the travel speeds are the same.

In another advantageous embodiment, the longitudinal welding bar or the pair of longitudinal welding bars is oriented perpendicular to the supply direction of the inner layers that are to be welded in the apparatus. Preferably, the longitudinal welding bar pair(s) is/are arranged in the form of a welding tower so that the layers that are to be welded are welded in the welding tower, perpendicular to the floor on which the apparatus rests. The supply direction in the apparatus is preferably parallel to the floor and therefore horizontal.

In another advantageous embodiment, the apparatus has at least one insulating strip of Teflon. Usually, the apparatus has a plurality of insulating strips because of the plurality of longitudinal welds that are to be welded.

In another advantageous embodiment, the apparatus has at least one supply roll for supplying at least one film layer.

In another advantageous embodiment, the apparatus has at least one triangular folder. The triangular folder can be used to fold a film layer.

In another advantageous embodiment, the apparatus has a winder for winding the produced packs.

The apparatus according to the invention also has at least one deflector rod, at least one draw roller pair, at least one appropriate drive motor for driving the draw roller pair, at least one deflection roll, and the like. These components are familiar to the person skilled in the art in apparatuses for welding layers of plastic film and are not described in detail.

A pack according to the invention for articles and the preferred advantageous embodiment thereof are described in detail below:

The pack according to the invention for articles, in particular containers, is produced according to the invention with the method according to one of claims 1 through 27.

In an advantageous embodiment, the pack is an outer packaging.

In another advantageous embodiment, the pack has a height that is adapted to the respective article to be packed and a width that is adapted to the respective article to be packed. The pack can thus be used, for example, to package 3-liter canisters, 4-liter canisters, 5-liter canisters, or the like. It can also be used to pack small cans such as food-preserving containers of sheet metal or medications such as cough drops in a round glass container for private use. The dimensions of the respective pack are thus appropriately adapted to the article that is to be packed, preferably according to the size and/or shape of the article.

In another advantageous embodiment, the pack has a height of 142 mm to 162 mm, preferably 152 mm, and a width of 307 mm to 347 mm, preferably 327 mm.

In another advantageous embodiment, the pack is rolled onto a takeup roll. After a plurality of packs has been wound, this constitutes a string of packs.

The invention also relates to a string of packs; the string of packs has at least two packs according to one of claims 36 through 38. The packs are detachably connected in a string, one after the other in the production direction.

The figures show preferred embodiments according to the invention. In the drawings,

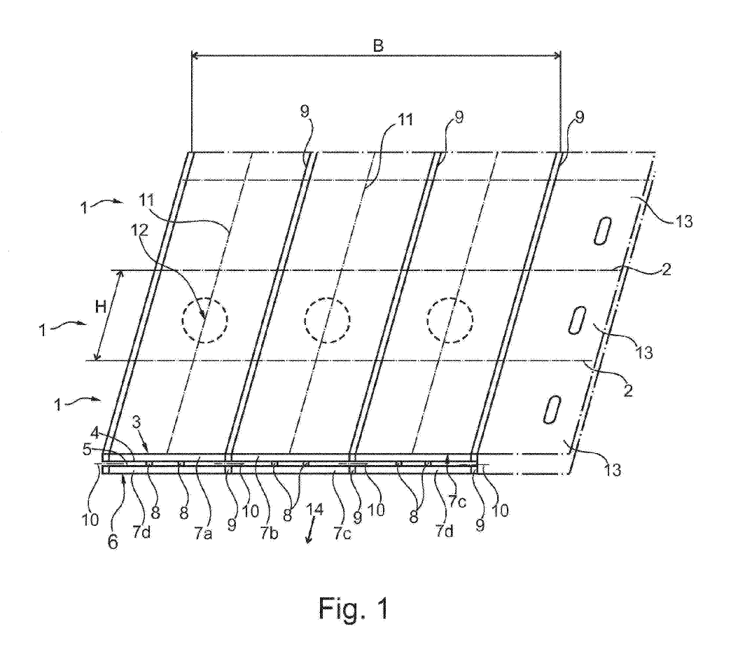

FIG. 1 shows a plurality of two-row packs for articles, each pack being formed by four layers of plastic film and having six compartments, assembled in the form of a string of packs,

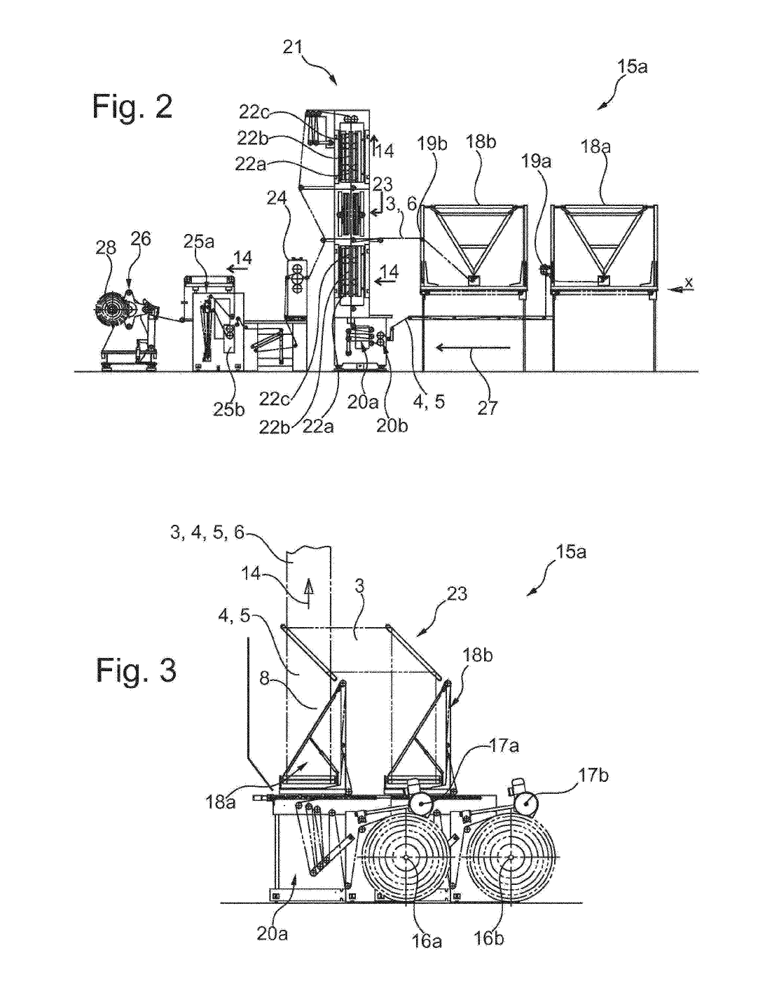

FIG. 2 is a front view of an apparatus having two triangular folders for making two-row packs,

FIG. 3 is a view in direction X of the apparatus,

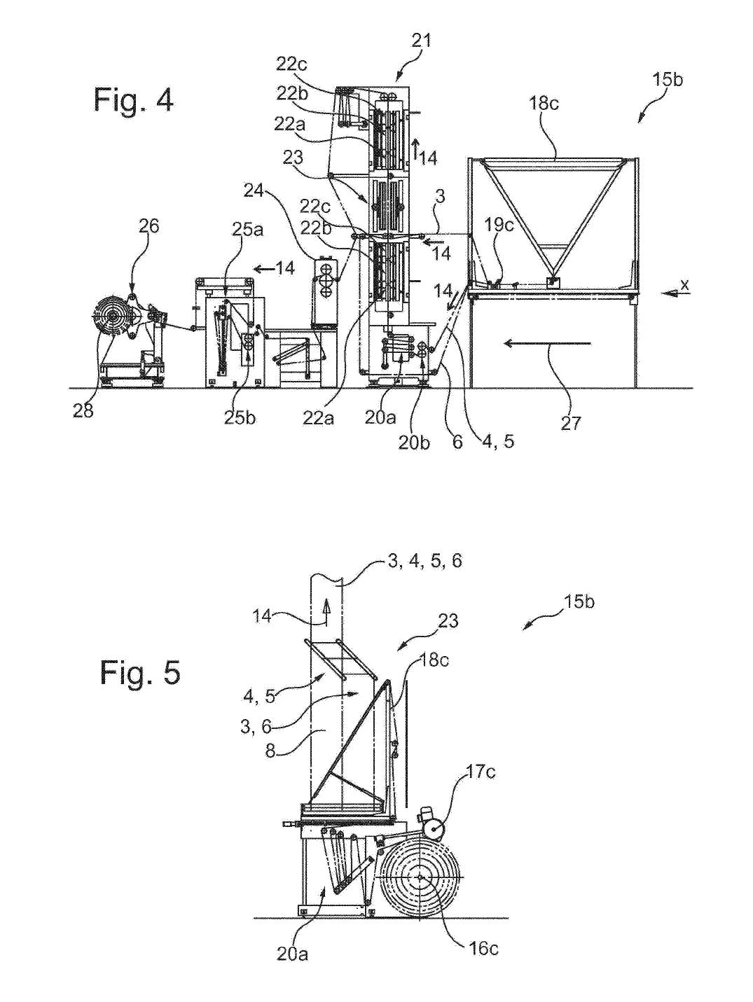

FIG. 4 is a front view of an apparatus having one triangular folder for making two-row packs

FIG. 5 is a view in direction X of the apparatus,

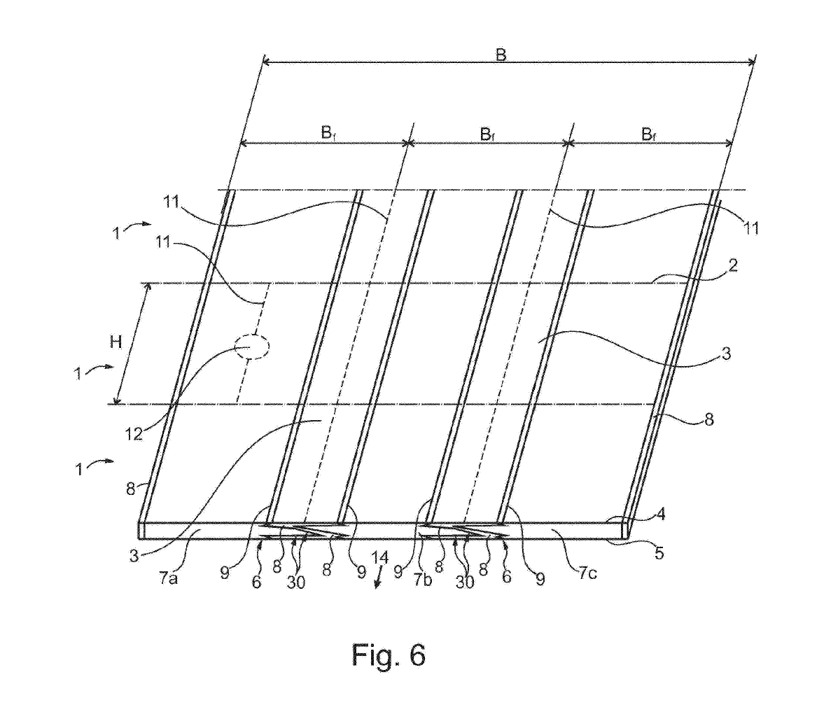

FIG. 6 shows a plurality of one-row packs as a string of packs,

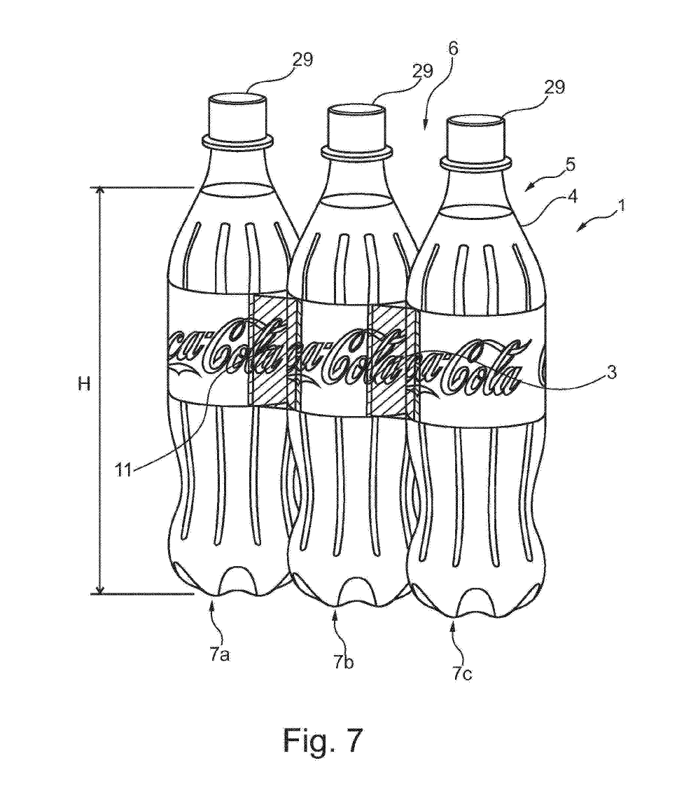

FIG. 7 is a front view of a one-row pack filled with bottles,

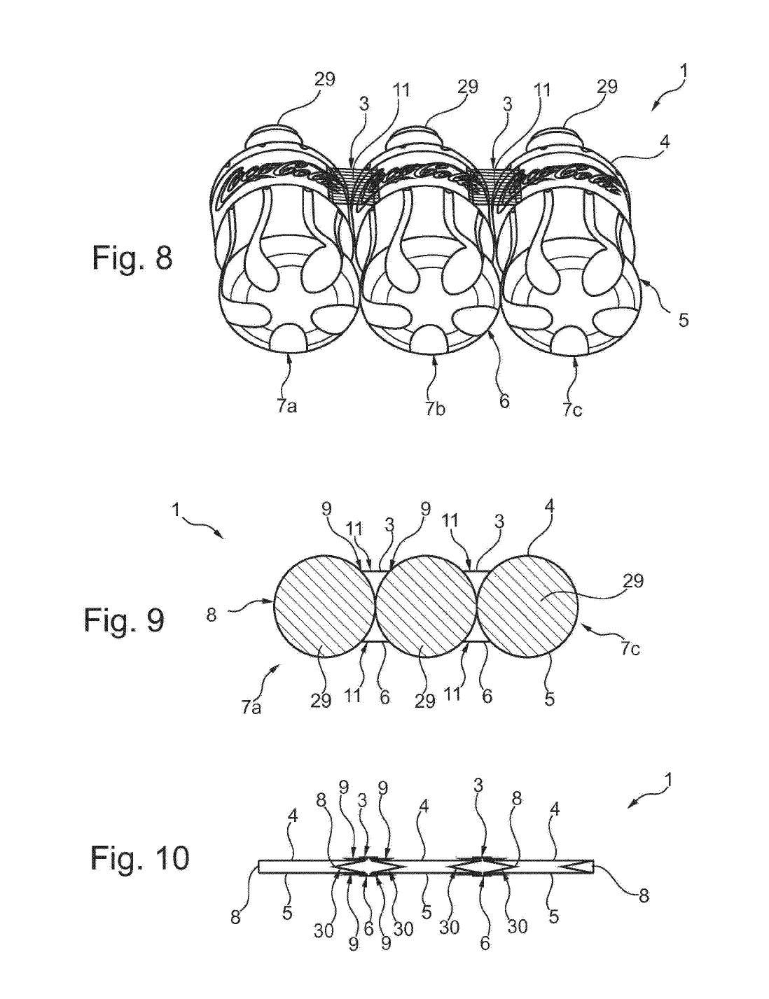

FIG. 8 is a bottom view of the one-row pack,

FIG. 9 is a cross-section through the one-row pack,

FIG. 10 is a technical view of the pack,

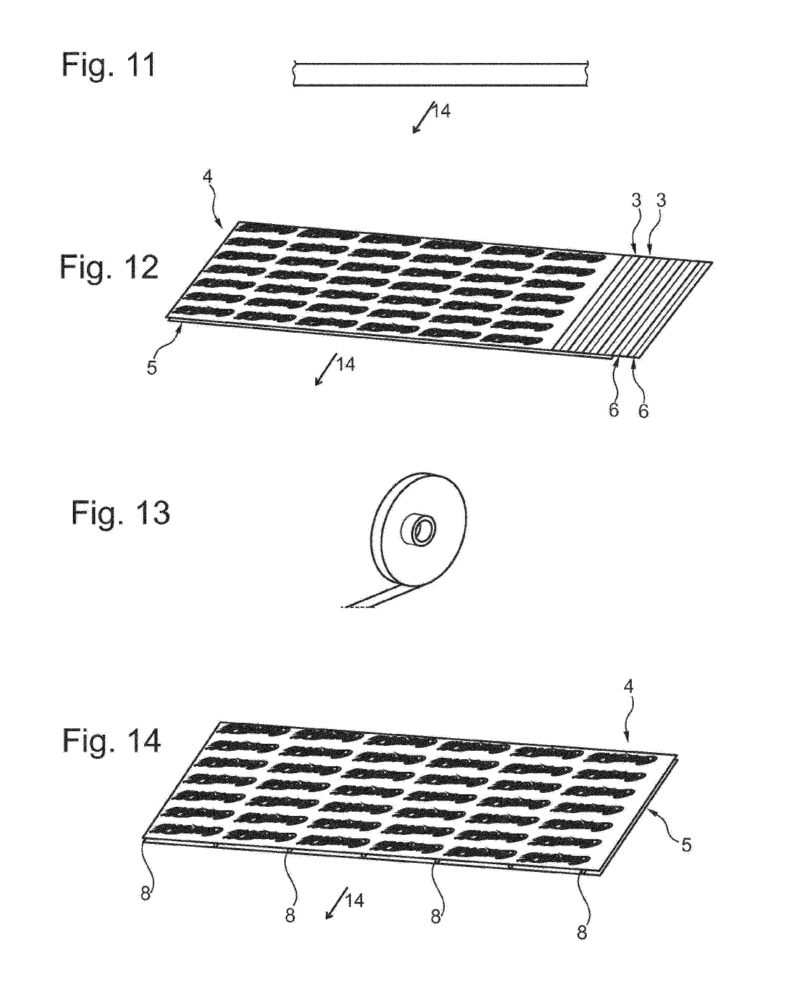

FIG. 11 shows a film layer for making one-row packs,

FIG. 12 shows two inner layers of plastic film resting one on top of the other,

FIG. 13 shows an outer layer in the form of a glued strip on a roll,

FIG. 14 shows the welded-together inner layers of plastic film,

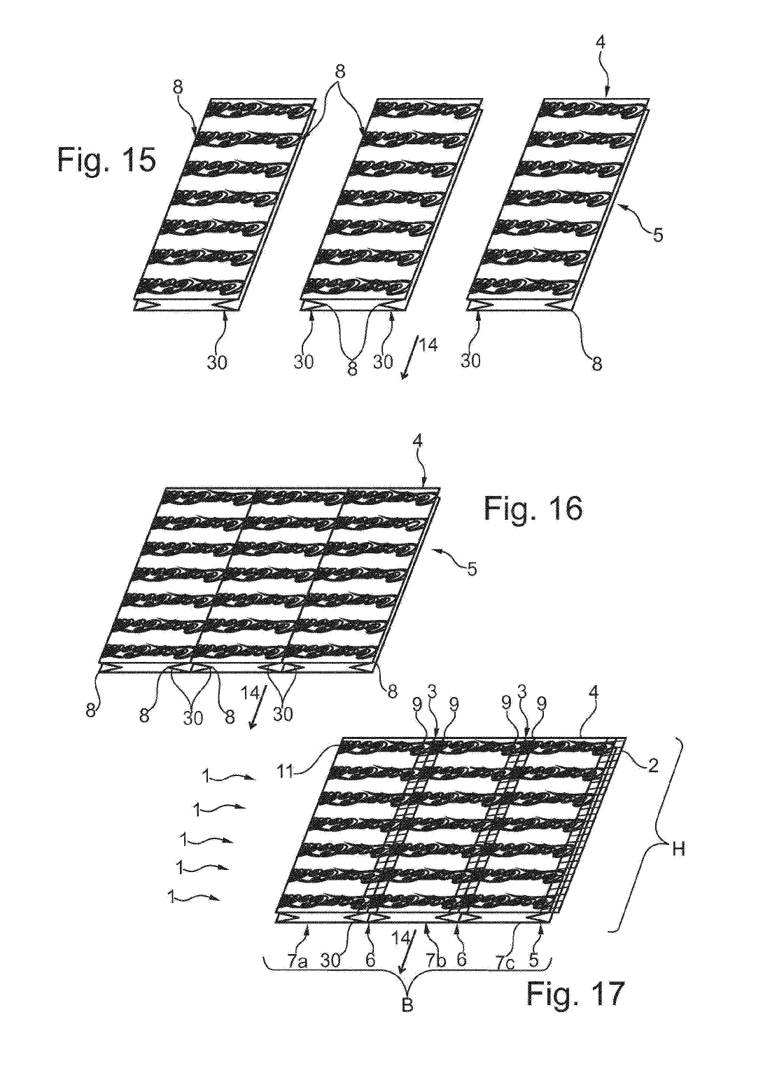

FIG. 15 shows the cut and folded layers of plastic film,

FIG. 16 shows the cut and folded layers of plastic film juxtaposed with one another,

FIG. 17 shows the inner layers with respective outer layers in the form of strips welded to each side of the inner layers, and

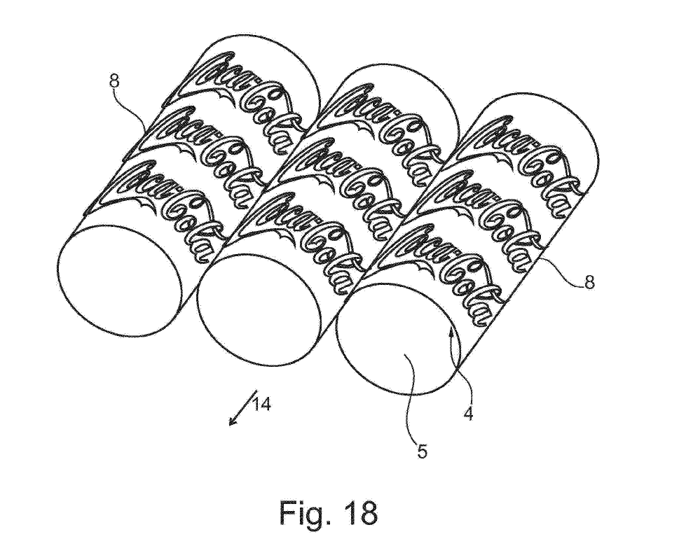

FIG. 18 shows the preopened inner layers before being welded to the strips.

Parts that remain the same are identified with the same reference numerals in the figs and new parts are provided with new reference numerals in the figures.

FIG. 1 shows a plurality of packs 1 for packaged articles, in particular containers. The packs 1 according to FIG. 1 are arranged detachably in a string with one another and are delimited from one another by pattern repeat perforation lines 2. The packs 1 can be separated from one another along the respective pattern repeat perforation line 2. The produced packs 1, as a connected, arbitrarily long string of a plurality of packs 1, are thus formed as a string of packs.

One of the three packs 1 shown in FIG. 1 will be described below.

According to FIG. 1, an individual pack 1 is formed by four layers 3, 4, 5, and 6 of plastic film resting one on top of the other. At least the two outer layers 3 and 6 are made of a bidirectionally shrinkable plastic film.

The individual pack 1 in the illustrated embodiment has a height H of approximately 152 mm and a width B of approximately 327 mm. Other dimensions are alternatively possible, but are not provided in the pack 1 in the illustrated embodiment.

According to FIG. 1, each pack 1 also has six compartments 7a, 7b, 7c, 7d, 7e, and 7f. The compartments 7a, 7b, 7c, 7d, 7e, and 7f are arranged in the pack 1 to produce a 2×3 array of the compartments 7a, 7b, 7c, 7d, 7e, and 7f. The pack 1 thus formed as a two-row pack 1 that has three compartments 7a, 7b, 7c, 7d, 7e, and 7f each in two rows (2×3 six pack). It is thus possible to pack six articles in the pack 1.

The compartments 7a, 7b, 7c of the one side of the two-row pack 1 are formed by the outer layer 3 and the inner layer 4 of the pack 1. The other three compartments 7d, 7e, and 7f of the pack 1 are formed by the outer layer 6 and the inner layer 5 of the pack 1.

To form the compartments 7a, 7b, 7c, 7d, 7e, and 7f, according to FIG. 1, the two inner layers 4 and 5 are each welded with two longitudinal welds 8 at the compartments 7a, 7b, 7c, 7d, 7e, and 7f. The individual pack 1 shown in FIG. 1 therefore has six longitudinal welds 8 between the inner layers 4 and 5, with two longitudinal welds 8 at each of the compartments 7a, 7b, 7c, 7d, 7e, and 7f.

The one outer layer 3 according to FIG. 1 is welded to the inner layer 4 with the aid of four longitudinal welds 9. The other outer layer 6 is also welded to the respective inner layer 5 by four longitudinal welds 9. The longitudinal welds 9 here delimit the compartments 7a, 7b, 7c, 7d, 7e, and 7f of a pack 1.

When welding the outer longitudinal welds 9 during the production of the pack 1, in order to prevent the two inner layers 4 and 5 from being welded along with them, several separators are shown by way of example in FIG. 1, at the longitudinal welds 9 that are to be welded, between the two inner layers 4 and 5 that prevent the two inner layers 4 and 5 from being welded. In FIG. 1, the means are a Teflon insulating strip 10; according to FIG. 1, four insulating strips 10 are used to prevent welding. The insulating strips 10 are thus a mechanical means for preventing welding-together.

The three packs 1 shown by way of example in FIG. 1 each have a detachment perforation line 11 passing through the two outer layers 3 and 6 at the respective compartments 7a, 7b, 7c, 7d, 7e, and 7f. The detachment perforation lines 11 in the illustrated embodiment are produced by punching and extend parallel to the longitudinal weld 8 of the inner layers 4, 6. The detachment perforation line 11 makes it possible to remove a container, not shown in FIG. 1, from one of the six compartments 7a, 7b, 7c, 7d, 7e, and 7f of the pack 1. To this end, the container is snugly held in one of the six compartments 7a, 7b, 7c, 7d, 7e, and 7f, for example by prior heating action to trigger shrinkage of at least the outer layers 3 and 6. During removal, a part of the outer layer 3, 6 belonging to the respective compartment 7a, 7b, 7c, 7d, 7e, and 7f tears at the detachment perforation line 11 so that the container can be easily removed from the pack 1.

Alternatively or in addition to the detachment perforation lines 11 according to FIG. 1, it is possible for at least one label 12 to be provided at each of the compartments 7a, 7b, 7c, 7d, 7e, and 7f in at least the two outer layers 3 and 6 of the respective pack 1 according to FIG. 1. For example, in the middle pack 1 in FIG. 1, each of the three compartments 7a, 7b, 7c has a label 12 shown in dashed lines.

Consequently, a part of the outer layer 3 forms for example the label 12 for the article. According to FIG. 1, a perforation line or a precut is provided around the edge of the label 12 to permit removal of the label 12; the perforation line or precut is directly adjacent to the respective detachment perforation line 11. In addition, the label 12 has a reactive glue on the side of the respective layer 3 that is turned toward the respective article (article not shown in FIG. 1) so that when the respective article is removed from the pack 1, the label 12 remains on the article after the label 12 has been torn out of the pack 1 together with the pack 1 with the aid of the perforation line or precut and the detachment perforation line 11. WO 2011/116851 [US 2013/0071585] discloses labels of this kind and a method of making packs having labels by transverse welding.

It is also possible for the pack 1 to have a handle strip 13. The packs 1 according to FIG. 1 do not all have a handle strip 13. A handle strip 13 is, however, shown by way of example for one of the packs 1 is formed by the outer layer 3 and the outer layer 6. In addition, a grab hole for carrying the respective pack 1 is shown in each handle strip 13.

A number of the packs shown in FIG. 1 are rolled onto a takeup roll, for example, producing a string of packs. The takeup roll is not shown in FIG. 1. For winding onto a takeup roll and for the prior production of the above-described longitudinal welds 8, 9, the layers 3, 4, 5, and 6 are continuously moved and welded in the production direction 14 in the illustrated embodiment.

Descriptions will be provided below for two different apparatuses 15a and 15b for making the packs 1 shown in FIG. 1 that are of plastic film and are for articles, in particular containers.

FIGS. 2 and 3 show a particularly preferred apparatus 15a in which the two inner layers 4 and 5 are formed by one film layer that is unwound from a supply roll 16a and the two outer layers 3 and 6 are formed by another film layer that is unwound from a supply roll 16b.

By contrast, the alternative preferred apparatus 15b according to FIGS. 4 and 5 has only a single supply roll 16c. A single film layer is wound onto this roll 16c that is then used to form the four layers 3, 4, 5, and 6 of the respective pack 1 in the course of production in the apparatus 15b.

The particularly preferred apparatus 15a according to FIGS. 2 and 3 will be described first.

According to the above explanations, the apparatus 15a has two supply rolls 16a and 16b for supplying the two separate film layers. The apparatus 15a according to FIG. 3 has a respective unwinder 17a, 17b at each supply roll 16a and 16b. The apparatus 15a according to FIGS. 2 and 3 has a respective triangular folder 18a, 18b for each film layer. The apparatus 15a also has a respective means 19a and 19b for making a detachment perforation line at each triangular folder 18a, 18b. In the supply direction 27, the four layers 3, 4, 5, and 6 are supplied to the following elements of the apparatus 15a according to FIG. 2. The supply direction 27 is parallel to the floor on which the apparatus 15a rests.

In addition, the apparatus 15a according to FIGS. 2 and 3 has an buffer 20a with a draw roller pair 20b.

At the buffer 20a, the insulating strips 10 are inserted between the two inner layers 4 and 5. The insulating strips 10 are of Teflon.

The apparatus also has a unit in the form of a welding tower 21 for welding the layers 3, 4, 5, and 6. In the illustrated embodiment according to FIGS. 2 and 3, the welding tower 21 has three pairs of longitudinal welding bars 22a, 22b, and 22c arranged in a row one after another in the production direction 14 for each longitudinal weld 8 that is to be made. The apparatus also has three pairs of longitudinal welding bars 22a, 22b, and 22c arranged in a row one after another in the production direction 14 for each longitudinal weld 9 that is to be made. The pairs of longitudinal welding bars 22a, 22b, and 22c for the longitudinal welds 8 and the pairs of longitudinal welding bars 22a, 22b, and 22c for the longitudinal welds 9 are spaced apart from each other according to FIG. 2. The length of a continuously heated longitudinal welding bar of a pair of longitudinal welding bars 21a, 21b, 21c [22a, 22b, and 22c] is approximately 250 mm in the illustrated embodiment according to FIGS. 2 and 3.

The first pairs of longitudinal welding bars 22a, 22b, and 22c each have, on one of the two sides on which the respective welding bar edge of the respective longitudinal welding bar, a separately driven, endlessly revolving Teflon belt traveling at the same travel speed as the layer 4, 5. The Teflon belt therefore passes between the edges of the welding bars and the respective adjacent inner layer 4 or 5.

The second pairs of longitudinal welding bars 22a, 22b, and 22c also each have, on one of the two sides of the welding bar edge of the respective longitudinal welding bar, a separately driven, endlessly revolving Teflon belt traveling at the same travel speed as the layers 3, 4, 5, and 6. The Teflon belt thus passes between the respective edges of the welding bars and the respective adjacent outer layer 3 or 6.

According to FIGS. 2 and 3, the welding tower 21 is vertical and perpendicular to the floor on which the apparatus 15a rests. According to FIGS. 2 and 3, the layers 3, 4, 5, and 6 that are guided through the apparatus 15a for making the respective pack 1 are thus guided perpendicular to the floor in the welding tower 21 so that welding at the pairs of longitudinal welding bars 22a, 22b, and 22c is carried out at an ever-increasing height with a travel direction oriented in the production direction 14. In this case, the two inner layers 4 and 5 are first conveyed vertically and then, after the two outer layers 3 and 6 are supplied, all of the layers 3, 4, 5, and 6 are conveyed in the production direction 14, i.e. vertically according to FIGS. 2 and 3. According to FIGS. 2 and 3, therefore, the pairs of longitudinal welding bars 22a, 22b, and 22c are perpendicular to the supply direction 27 of the inner layers 4 and 5 that are to be welded in the apparatus 15a.

Alternatively, it is also possible for movement to occur at increasingly lower levels perpendicular to the floor in the welding tower 21 of the apparatus 15a so that the travel direction during the welding is reversed 180°. This is not the case, however, in the illustrated embodiment.

The apparatus 15a also has suitable deflection rolls and the like in order to appropriately supply the respective layers 3, 4, 5, and 6 from the triangular folders 18a and 18b to the welding tower 21 according to FIGS. 2 and 3.

The apparatus 15a also has a plurality of deflector rods 23.

The two outer layers 3 and 6 and the two inner layers 4 and 5 according to FIG. 2 are each shown between the triangular folder 18a and the welding tower 21. The two inner layers 4 and 5 and one outer layer 3 are shown by way of example in FIG. 3; the outer layer 3 is supplied via the deflector rods 23. The other outer layer 6 travels below the outer layer 3 according to FIG. 3 and is also conveyed to the two inner layers 4 and 5 via the deflector rods 23.

The apparatus 15a according to FIGS. 2 and 3 also has means for making a pattern repeat perforation line 24.

The apparatus 15a also has a buffer 25a with a draw roller pair 25b.

In addition, the apparatus 15a according to FIGS. 2 and 3 has a winder 26. The winder 26 is an automatic winding station in which finished packs 1 that are attached to one another are wound onto one of the two takeup rolls 28 of the winder 26.

The remainder of the machine parts of the apparatus 15a that are familiar to the person skilled in the art and shown in FIGS. 2 and 3 are not described in detail.

Only the differences between the apparatus 15b shown in FIGS. 4 and 5 and the apparatus 15a shown in FIGS. 2 and 3 will be described below. The apparatus 15b does not differ from the apparatus 15a with regard to other features and components.

The apparatus 15b shown in FIGS. 4 and 5 has only a single supply roll 16c on which a single film layer is wound. The apparatus 15b according to FIG. 5 also has only a single unwinder 17c. In addition, the apparatus 15b shown in FIGS. 4 and [5] has only a single triangular folder 18c. Furthermore, the apparatus 15b according to FIGS. 4 and 5 has only a single means 19c for making a detachment perforation line.

In FIGS. 4 and 5, the two inner layers 4 and 5 and the two outer layers 3 and 6 are each shown between the triangular folder 18c and the welding tower 21. The apparatus 15b also has suitable deflector rods 23 and the like in order to appropriately convey the respective layers 3, 4, 5, and 6 from the region of the triangular folder 18c to the welding tower 21 according to FIGS. 4 and 5.

The remainder of the components of the apparatus 15b shown in FIGS. 4 and 5 such as the welding tower 21 and the other components of the apparatus 15b shown in FIGS. 4 and 5 respectively correspond to the embodiment described above in conjunction with the apparatus 15a shown in FIGS. 2 and 3.

A method of making the packs 1 shown in FIG. 1 out of plastic film for articles, in particular containers, will be described below.

The manufacturing method with the particularly preferred apparatus 15a according to FIGS. 2 and 3 will be described first. This manufacturing method is particularly preferred.

First, a film layer is unwound from each of the supply rolls 16a and 16b with the aid of the respective unwinders 17a and 17b. A bidirectionally shrinkable plastic film according to the above is used for at least the film layer on the supply roll 16b.

In the illustrated embodiment, the film layers that are unwound from the respective supply rolls 16a and 16b are already printed. In this case, the two inner layers 4 and 5 are so-called random-printed films and the two outer layers are precisely printed with a logo or the like.

Then, each film layer is conveyed to the respective triangular folder 18a, 18b. The film layer unwound from the supply roll 16a is fed to the triangular folder 18a and the film layer unwound from the supply roller 16b to the triangular folder 18b.

In the triangular folders 18a and 18b, the film layer in the illustrated embodiment according to FIGS. 2 and 3 are first folded over. As a result, it then constitutes two layers resting one on top of the other that are still connected to each other along the respective folding edge.

The two respectively folded film layers are then cut apart. The two inner layers 4 and 5 for making the respective packs 1 according to FIG. 1 are thus produced from the folded and cut film layer that is unwound from the supply roll 16a. The two outer layers 3 and 6 in this case are consequently produced from the other folded and cut film layer that is unwound from the supply roll 16b.

Then the means for making a detachment perforation line 19b according to FIG. 2 is used to produce a detachment perforation line 11 according to FIG. 1 in the two outer layers 3 and 6, at the succeeding compartments 7a, 7b, 7c, 7d, 7e, and 7f. This detachment perforation line can be produced, for example mechanically, in a known way by a knife roller and a cutting roller. The means 19a for making a detachment perforation line can also produce detachment perforation lines 11 in the two inner layers 4 and 5. This is not the case, however, in the illustrated embodiment according to FIGS. 1 through 3.

In the illustrated embodiment, the detachment perforation lines 11 are continuously punched in the outer layers 3 and 6 during production. In this case, the detachment perforation lines 11 are punched into the respective layers 3, 6 as described above so that they are parallel to the longitudinal weld 8 that has not yet been formed. When the detachment perforation lines 11 are produced, the longitudinal welds 8 have not yet been welded.

Then, the inner layers 4 and 5 are conveyed in the supply direction 27 to the buffer 20a with the aid of the draw roller pair 20b. The two inner layers 4 and 5 are thus conveyed to the welding tower 21. In addition, the two outer layers 3 and 6 are supplied to the welding tower 21 in accordance with FIG. 2.

The two inner layers 4 and 5 resting one on top of the other are then continuously welded in the production direction 14 in the welding tower 21 with six longitudinal welds 8 according to

FIG. 1 by conveying the layers 4, 5 continuously through the first pairs of longitudinal welding bars 22a, 22b, and 22c. For each longitudinal weld 8 that is to be welded, three pairs of longitudinal welding bars 22a, 22b, and 22c are arranged in a row so that when there are a total of six longitudinal welds 8 to be welded, six times three pairs of longitudinal welding bars 22a, 22b, and 22c are used in the apparatus 15a. In this case, the inner layers 4 and 5 that are to be welded are welded by the first pair of longitudinal welding bars 22a, 22b, and 22c of the welding tower 21 in a direction perpendicular to the supply direction 27 of the inner layers 4 and 5 that are to be welded, i.e. perpendicular to the floor. In FIG. 3, six longitudinal welds 8 are also shown by way of example that have been formed in the apparatus 15a with the aid of the first pairs of longitudinal welding bars 22a, 22b, and 22c.

Before the two inner layers 4 and 5 are welded least one means is inserted between the two inner layers 4 and 5 in order to prevent the two inner layers 4 and 5 from being welded together during the welding to the respective outer layers 3 and 6. According to the above explanations, means is used that is formed as a mechanical separating means in the form of a plurality of insulating strips 10 that are appropriately inserted between the two inner layers 4 and 5 before welding of the two inner layers 4 and 5. The inner layers 4 and 5 thus enclose the insulating strips 10, with the inner layers 4 and 5 continuously sliding over the insulating strips 10.

Then the two outer layers 3 and 6, which have the same travel speed as the two inner layers 4 and 5, are each pushed against the respective inner layer 4, 5 with the aid of the deflector rods 23 according to FIGS. 2 and 3. Consequently, the one outer layer 3 is placed against the layer 4 that is welded to the layer 5. The other outer layer 6 is placed against the other side of the already welded layers 4, 5; i.e. the layer 6 is engaged against the layer 5. In the illustrated embodiment, the two outer layers 3 and 6 are laid in such a way that both of the outer layers 3 and 6 are placed before each of the outer layers 3 and 6 is fastened to the respective inner layer 4, 5. For example a pattern repeat unit that is not shown can be used to perform this laying with a precise pattern repeat matching so that for example a logo or the like is at the subsequently produced compartments 7a, 7b, 7c, 7d, 7e, and 7f.

Then the four layers 3, 4, 5, and 6 are continuously welded to one another in accordance with FIG. 1. To accomplish this, the four layers 3, 4, 5, and 6 are continuously conveyed in the production direction 14 to the second pairs of longitudinal welding bars 22a, 22b, and 22c in accordance with FIG. 3. In the upper region of the welding tower 21, the apparatus 15a therefore has four times three pairs of longitudinal welding bars 22a, 22b, and 22c, with each longitudinal weld 9 being welded by the respective second three pairs of longitudinal welding bars 22a, 22b, and 22c.

On the one side of the respective pack 1 to be produced, the one outer layer 3 is thus continuously welded in the welding tower 21 to the welded-together inner layers 4 and 5 with four longitudinal welds 9 in the production direction 14 in accordance with FIG. 1.

During the welding process, the outer layer 3 is continuously fastened to the inner layer 4, which has already been welded to the inner layer 5, as it passes through the welding tower 21.

On the other side of the respective pack 1 to be produced in accordance with FIG. 1, the other outer layer 6 is also welded to the second inner layer 5, likewise with the aid of respective second pairs of longitudinal welding bars 22a, 22b, and 22c. Consequently, the second, other outer layer 6 is continuously fastened to the inner layer 5, which has already been welded to the inner layer 4, as it passes through the welding tower 21.

As the four layers 3, 4, 5, and 6 are continuously welded together in the production direction 14, the two inner layers 4 and 5, which have already been welded together, are kept apart from each other with the aid of the respective insulating strip 10 in order to prevent another welding together of the two inner layers 4 and 5.

It is alternatively possible for the respective layers 3, 4, 5, and 6 according to the above description to be welded in steps in the welding tower 21 or for them to be welded in a partially step-wise, partially continuous fashion. This is not the case, however, in the illustrated embodiment.

A subsequent cooling of the welded layers 3, 4, 5, and 6, in particular a cooling of the welded longitudinal welds 8, 9, is also possible in the apparatus 15a.

Then, the four layers 3, 4, 5, and 6 that are welded to one another are conveyed to means 24 for making a pattern repeat perforation line in accordance with FIG. 2. In the illustrated embodiment, the means 24 for making a pattern repeat perforation line makes at least one pattern repeat perforation line 2 in the four layers 3, 4, 5, and 6 according to FIG. 1, perpendicular to the longitudinal weld 8 of the inner layers 4 and 5. In the illustrated embodiment, pattern repeat perforation lines 2 are continuously punched into the four layers 3, 4, 5, and 6 one after the other, extending through all four layers 3, 4, 5, and 6, with two adjacent pattern repeat perforation lines 2 spaced apart by a height H being provided in all four layers 3, 4, 5, and 6. The height H of the compartments 7a, 7b, 7c, 7d, 7e, and 7f corresponds to this pattern repeat length.

Then the four layers 3, 4, 5, and 6 are conveyed to a buffer 25a with the aid of the draw roller pair 25b. The purpose of the buffer 25a is on the one hand to perform a corrective storage function. On the other hand, the buffer 25a also performs a compensating function.

The corrective function lies in the fact that when the four layers 3, 4, 5, and 6 are wound onto the winder 26, the speed changes due to the changing diameter of the takeup roll 28. The buffer 25a corrects this.

On the other hand, the winder 26 has two arms for each takeup roll 28, thus enabling a continuous winding onto a respective one of the two takeup rolls 28. During the change from the one arm of the winder 26 to the other arm of the winder 26, the buffer 25a compensates for this winding procedure, which takes time. A change is necessary, for example, when the maximum winding diameter of the takeup roll 28 is reached.

The packs 1 wound onto takeup rolls 28 can then be filled with articles, such as containers in the form of bottles or the like, for example in another apparatus that is not shown in FIGS. 2 and 3. After a shrinkage procedure following the filling, the bottles are each firmly seated in the respective compartment 7a, 7b, 7c, 7d, 7e, and 7f, as a rule with each compartment 7a, 7b, 7c, 7d, 7e, and 7f being filled with one respective bottle.

When making the packs 1 in the apparatus 15a according to FIG. 1, it is alternatively possible to print each layer 2, 3, 4, 5 [3, 4, 5, and 6] in the apparatus 15a according to FIGS. 2 and 3 instead of using preprinted film layers. It is also alternatively possible in this connection to carry out a corona pretreatment in the apparatus 15a before the printing takes place in the apparatus 15a. For a corona pretreatment, the apparatus 15a according to FIGS. 2 and 3 preferably has appropriate openings that permit a continuous pretreatment with regard to the illustrated embodiment, in precise regions of the respective film layer. A corona pretreatment and a printing, however, are not carried out in the apparatus 15a in the illustrated embodiment according to FIGS. 2 and 3.

Alternatively, it is also possible to use a separating lacquer as the separating means. Preferably, the inner face of the one inner layer 4 and/or the inner face of the second inner layer 5 has been coated with separating lacquer before the two inner layers 4 and 5 are welded. The separating lacquer effectively separate the two inner layers 4 and 5 that have already been welded previously in the regions in which the separating lacquer has been applied as they are being welded to the two outer layers 3 and 6. A welding of the two inner layers 4 and 5 is consequently prevented with the aid of the separating lacquer when each outer layer 3, 6 is welded with at least one longitudinal weld 9 to the two welded-together inner layers 4 and 5 in accordance with the descriptions above. In the illustrated embodiment, however, separating lacquer is not used.

In addition, it is also possible on the one hand, that during the production of the packs 1 according to FIG. 1 in the apparatus 15a according to FIGS. 2 and 3, at least one handle strip 13 is attached to each respective pack 1. On the other hand, it is also possible for at least one handle strip 13 to be provided in—in particular punched into—the respective layers 3, 4, 5, and 6, preferably in the two outer layers 3 and 6. According to the above explanations, however, this is not the case in the apparatus 15a in the illustrated embodiment according to FIGS. 2 and 3 and furthermore, the apparatus 15a has no appropriate means for this.

In addition, it is also possible that during the production of the packs 1 according to FIG. 1 in the apparatus 15a according to FIGS. 2 and 3, a respective part of the outer layer 3, 6 and/or a part of the inner layer 4, 5 is formed as a label 12 for the article; when the article is removed from the finished pack 1, the label 12 remains on the article itself. In this case, preferably the labels 12 are each positioned in the middles of the compartments 7a, 7b, 7c, 7d, 7e, and 7f during production in an apparatus 15a according to FIG. 1. The shape of the labels 12 in this case is preferably produced before the longitudinal welding of the longitudinal welds 8, 9.

In the apparatus 15a, a perforation line or a precut for removal of the label 12 is preferably provided at the edge of the label 12 and the labels are provided with a reactive glue on the side of the respective layer 3, 4, 5, and 6 that is turned toward the article.

It is also possible for the shape of the labels 12 to be produced in each layer 3, 4, 5, and 6 with the aid of the means for making a detachment perforation line 19a, 19b. The means for making a detachment perforation line 19a, 19b is not limited to a linear profile or the like, thus allowing any shape of label 12—or example a curved shape, an elliptical shape, or the like—to be provided by the means for making a detachment perforation line 19a, 19b.

According to the above explanations, when the packs 1 according to FIG. 1 are produced in the apparatus 15a according to

FIGS. 2 and 3, no a label 12 is produced in the respective layer 3, 4, 5, and 6.

The manufacture of the pack 1 according to FIG. 1 in an apparatus 15b according to FIGS. 4 and 5 is described below. In particular, a detailed description is given of those production steps that differ from above-described the production steps in the apparatus 15a.

To produce the pack 1, which is of plastic film and has six compartments 7a, 7b, 7c, 7d, 7e, and 7f for articles, in particular containers, a single film layer is unwound from a supply roll 16c with the aid of an unwinder 17c according to FIG. 5. In the illustrated embodiment, a bidirectional plastic film is used for the film layer.

In the illustrated embodiment, the film layer that is used in the apparatus 15b is printed. After the film layer is folded and cut into four layers 3, 4, 5, and 6 as described below, these layers are still arranged with precise pattern repeat matching since they have been folded and cut from a single film layer. It is thus possible to supply the individual layers 3, 4, 5, and 6 to the welding tower 21 independent of the pattern repeat in accordance with the following description.

Alternatively, it is possible to print the film layer or the individual layers 3, 4, 5, and 6 in the apparatus 15b itself. In addition, it is also possible in this case to carry out a corona pretreatment along with this in the apparatus 15b. This is not the case, however, in the illustrated embodiment.

After unrolling, the film layer is supplied to a triangular folder 18c of the apparatus 15b according to FIGS. 4 and 5. In the triangular folder 18c, the film layer is folded and then cut so that according to FIGS. 4 and 5, four individual layers 3, 4, 5, and 6 are made from the single film layer.

The inner layers 4 and 5 and the outer layers 3 and 6 are thus produced from the single folded and cut film layer.

With the aid of the means 19c for making a detachment perforation line, a plurality of detachment perforation lines 11 are cut into the two outer layers 3 and 6, parallel to the longitudinal weld 8 of the inner layers 4 and 5 that have not yet been welded together in the welding tower 21. The detachment perforation lines 11 in this case are at the later formed compartments 7a, 7b, 7c, 7d, 7e, and 7f according to FIG. 1; in the illustrated embodiment, the detachment perforation lines 11 are produced by punching. When the detachment perforation lines 11 are being produced, the two inner layers 4 and 5 have therefore not yet been longitudinally welded together.

The four layers 3, 4, 5, and 6 are then supplied to the welding tower 21 in the supply direction 27. The supply direction 27 is parallel to the floor on which the apparatus 15b rests. In this case, the two inner layers 4 and 5 are supplied to the welding tower 21 resting against each other. According to FIGS. 4 and 5, the two outer layers 3 and 6 are conveyed to the welding tower 21 separately and not resting against each other.

According to FIGS. 4 and 5, the two inner layers 4 and 5 are then conveyed to the buffer 20a by the draw roller pair 20b. Before the welding of the two inner layers 4 and 5, four insulating strips 10 are inserted between the two inner layers 4 and 5 at the welding tower 21.

Alternatively, it is also possible for the inner face of the one inner layer 4 and/or the inner face of the second inner layer 5 to be or get coated with separating lacquer. This is not the case, however, in the illustrated embodiment.

Then the inner layers 4 and 5 enclosing the plurality of insulating strips 10 are conveyed to the first pairs of longitudinal welding bars 22a, 22b, and 22c in the welding tower 21. In the illustrated embodiment, the first pairs of longitudinal welding bars 22a, 22b, and 22c continuously weld the two inner layers 4 and 5 with six longitudinal welds 8 since the layers 4, 5 are continuously conveyed through the welding tower 21 that is oriented perpendicular to the floor. The two inner layers 4 and 5 that are to be welded are thus continuously welded by the first pairs of longitudinal welding bars 22a, 22b, and 22c in a travel direction oriented in the production direction 14, perpendicular to the supply direction 27 of the inner layers 4 and 5 that are to be welded. The six longitudinal welds 8 are also shown by way of example in FIG. 5 as well as FIG. 1.

In the illustrated embodiment according to FIG. 4, the two outer layers 3 and 6 are continuously conveyed to the two welded-together inner layers 4 and 5 with the aid of the deflector rods 23. The two outer layers 3 and 6 are then placed in such a way that both of the outer layers 3 and 6 are in place before the outer layers 3 and 6 are fastened to the respective inner layer 4, 5.

In this case, the one outer layer 3 according to FIGS. 4 and 5 is laid against the inner layer 4 at a travel speed equal to the travel speed of the inner layers 4 and 5. The outer layer is likewise laid against the inner layer 5 at a travel speed equal to the travel speed of the two inner layers 4 and 5.

Then the four layers 3, 4, 5, and 6 resting against one another are conveyed to the second pairs of longitudinal welding bars 22a, 22b, and 22c.

These second pairs of longitudinal welding bars 22a, 22b, and 22c continuously weld the one outer layer 3 to the adjacent inner layer 4 with four longitudinal welds 9; the two inner layers 4 and 5, which have already been welded previously, are kept apart from each other by the insulating strips 10 in order to prevent a welding-together of the two inner layers 4 and 5.

The second pairs of longitudinal welding bars 22a, 22b, and 22c also continuously weld the other outer layer 6 to the adjacent inner layer 5 with four longitudinal welds 9; here, too, the two inner layers 4 and 5, which have already been welded together, are kept apart from each other with the aid of insulating strips 10 in order to also prevent a welding-together of the two inner layers 4 and 5.

It is also alternatively possible for the respective layers 3, 4, 5, and 6 according to the above description to be welded in an wholly stepped fashion or for them to be welded in a partially step-wise, partially continuous fashion. This is not the case, however, in the illustrated embodiment.

In the apparatus 15b according to FIGS. 4 and 5, the steps following the welding in the welding tower 21 correspond to the production steps described in detail above in conjunction with the apparatus 15a according to FIGS. 2 and 3.

Consequently, the means for making a pattern repeat perforation line 24 is also used to produce the pattern repeat perforation lines 2 according to FIG. 1 in the layers 3, 4, 5, and 6. In addition, the buffer 25a and the respective draw roller pair 25b wind the layers 3, 4, 5, and 6 that are welded together in accordance with FIG. 1 onto a respective takeup roll 28 with the aid of a winder 26 according to the previous description.

It is also possible in the apparatus 15b according to FIGS. 4 and 5 for at least one handle strip 13 to be attached to the pack 1 or for at least one handle strip 13 to be provided in—in particular punched into—the layers 3, 4, 5, and 6, particularly the two outer layers 3 and 6. In the apparatus 15b in the illustrated embodiment according to FIGS. 4 and 5, however, this additional production step is not carried out.

It is also possible for a part of the outer layer 3, 6 and/or a part of the inner layer 4, 5 to be formed as a label 12 for the article; when the article is removed from the finished pack 1, the label 12 remains on the article.

Particularly when a single film layer is supplied, it is possible to provide a label 12 both on the inner layers 4 and 5 and on the two outer layers 3 and 6 since the respective layers 3, 4, 5, and 6 are supplied to the respective unit in the welding tower 21 with precise pattern repeat matching. According to the above description, the infeed of the layers 3, 4, 5, and 6 is independent of the pattern repeat.

The labels 12 in this case are preferably at the respective compartments 7a, 7b, 7c, 7d, 7e, and 7f.

The shape of the labels 12 in this case is produced before the longitudinal welding.

Particularly, a perforation line or a precut is provided at the edge of a label 12 for the removal of the label 12 and the labels 12 are preferably provided with a reactive glue on the side of the respective layer 3, 4, 5, and 6 that is turned toward the article. It is possible to provide the perforation line or precut with the aid of the means for making a detachment perforation line 19c.

In the apparatus 15b according to FIGS. 4 and 5, no label 12 is provided in the four layers 3, 4, 5, and 6 during the production of the packs 1 according to FIG. 1.

An alternative method of making packs 1 of plastic film, having at least one compartment 7a, 7b, 7c, 7d, 7e, and 7f for articles, in particular containers, a pack 1, and an apparatus are described below. First, the packs 1 are described:

FIG. 6 shows a plurality of packs 1. In the illustrated embodiment, a single pack 1 has a height H of approximately 152 mm and a width B of approximately 327 mm. Other dimensions are alternatively possible, but are not provided in the pack 1 shown in this illustrated embodiment.

The individual pack 1 is formed by a plurality of layers 3, 4, 5, and 6 of plastic film; in the illustrated embodiment, the inner layers 4 and 5 are formed by a bidirectionally shrinkable plastic film.

In the manufacture of the pack 1, the inner layers 4 and 5 of each pack 1 have each been produced from an upper, one-piece inner layer 4 and a lower, one-piece inner layer 5. In the produced pack 1 according to FIG. 6, a plurality of sections of the inner layers 4 and 5 have been produced that together constitute the original inner layers 4 and 5 used in the production. Consequently, in the following description, no distinction is drawn between inner layers 4 and 5 that exist in sections and constitute part of the respective inner layer 4, 5, and the complete, undivided inner layers 4 and 5, unless this is of particular significance.

According to FIG. 6, a pack 1 has three compartments 7a, 7b, and 7c in a row that are in particular formed by the inner layers 4 and 5. This is therefore a one-row pack. A pack of this kind is also referred to as a snake variant, snake chain, or chain sleeve. In the illustrated embodiment, the individual compartments 7a, 7b, 7c of a pack 1 each have a width B_{f} of approximately 109 mm. A number of packs 1 constitute a string of packs according to FIG. 6.

According to FIG. 6, the inner layers 4 and 5 are fused together at the outer edges of a respective pack 1 with a longitudinal weld 8. The inner layers 4 and 5 are also welded at a respective lateral fold 30—of which the pack 1 according to FIG. 1 has several—by a longitudinal weld 8. The lateral fold 30 at one compartment 7a, 7b, 7c of the pack 1 permits a subsequent simple filling, in which an article is inserted into the respective compartment 7a, 7b, 7c.

The four outer layers 3 and 6 of the respective packs 1 are each formed as a strip and are each welded to the respective inner layer 4, 5 by a longitudinal weld 9 according to FIG. 6, near the respective lateral fold 30. The “strip” is also referred to as a “dividing strip” or “connecting strip.” According to FIG. 6, the one outer layer 3 formed as a strip is welded to each of the two sectionally formed inner layers 4 by a respective longitudinal weld 9. The other of the two outer layers 6 is also welded to each of the sectionally formed adjacent inner layers 5, also by a respective longitudinal weld 9. The same is true for the other outer layers 3 and 6 formed as strips.

The individual packs 1 in a string of packs can be detached from one another by a pattern repeat perforation line 2 that extends through all of the layers 3, 4, 5, and 6 and is punched into the respective pack 1 perpendicular to the longitudinal welds 8 of the inner layers 4 and 5. The pattern repeat perforation line 2 in this case is produced in the layers 3, 4, 5, and 6 and spaced apart by the height H that corresponds to the height H of the compartments 7a, 7b, 7c.

The individual compartments 7a, 7b, 7c of each respective pack 1 can be detached from one another at perforation lines 11; each detachment perforation line 11 is punched into the two outer layers 3 and 6 according to FIG. 6 and extends through these two outer layers 3 and 6.

It is also possible for a label 12 to be provided in—in particular punched into—the sectionally formed inner layers 4 and 5. It is also possible to provide another detachment perforation line 11 at the compartments 7a, 7b, 7c adjoining the respective label 12. Preferably, with the presence of such labels 12 with a detachment perforation line 11 near the respective compartment 7a, 7b, 7c, the pack 1 has no detachment perforation lines 11 at the outer layers 3 and 6.

A label 12 and an additional detachment perforation line 11 are shown by way of example in one compartment 7a of a pack 1 in FIG. 6 and are shown by dashed lines. In the illustrated embodiment, the label 12, which in the illustrated embodiment is also surrounded by a perforation line to permit removal, and the detachment perforation line 11 are punched into the upper sectionally formed inner layer 4 (and are shown by dashed lines).

The pack 1 tears along the detachment line 11 and along the perforation line around the label 12 so that when the article is removed, it is torn out from the pack 1 together with the label 12.

When the article is removed from the respective pack 1, the label 12 therefore remains on the article since on the side turned toward the article, the label 12 is provided with a reactive glue or the like that causes the label 12 to adhere to the article. The compartment 7a is thus easy to open and the article is easy to remove from the pack 1.

According to the above explanations, the packs 1 according to FIG. 6 do not have a label 12 at the compartments 7a, 7b, 7c.

FIG. 6 also shows the production direction 14 for the production of the pack 1 shown in FIG. 6.

Preferably, the packs 1 produced in FIG. 6 are rolled onto a takeup roll so that they can then be taken from this roll and filled with articles in another apparatus.

FIGS. 7 through 10 each show an example of a single pack 1 according to FIG. 6.

In FIGS. 7 through 9, the individually shown pack 1 is filled with articles, here three bottles 29. The bottles 29 in this case are each inserted into an respective compartment 7a, 7b, 7c as shown in FIGS. 7 through 9. According to FIG. 9, the compartment 7a contains a bottle 29, the compartment 7b contains a bottle 29, and the compartment 7c contains a bottle 29. The three compartments 7a, 7b, 7c in this case are constituted by the inner layers 4 and 5 as described above.

To stabilize the three bottles 29 in the pack 1, the inner layers 4 and 5 are welded to the four outer layers 3 and 6 according to FIG. 6 that are formed as strips. In addition, the three bottles 29 in the respective pack 1 are shrink-wrapped in the respective pack 1 with the aid of bidirectionally shrinkable plastic film by a prior heating action.

To remove an individual bottle 29 from the respective pack 1 according to FIGS. 7 through 9, the bottle 29—together with the part of the inner layers 4 and 5 surrounding it and a part of the respective outer layer 3, 6—is detached from the remaining part of the pack 1 at the two detachment perforation lines 11. Parts of the layers 3, 4, 5, and 6 therefore remain around the removed bottle 29. These parts of the respective layers 3, 4, 5, and 6 can be appropriately printed with a logo or the like.

FIGS. 11 through 18 show the production of the packs 1 shown in FIGS. 6 through 10.

Packs 1 of this kind are produced in an apparatus for making packs 1 of plastic film, having at least one compartment 7a, 7b, 7c for articles, in particular for containers. The containers can, for example, be bottles 29. An apparatus is not shown in FIGS. 6 through 18.

The apparatus has at least one supply roll with an unwinder for supplying at least one film layer according to FIG. 11. The respective pack 1 is then produced from the at least one film layer. The apparatus also has at least one triangular folder that folds the supplied film layer.

The apparatus also has means for making a detachment perforation line.

In addition, the apparatus has at least one longitudinal welding bar or at least one pair of longitudinal welding bars. The length of a longitudinal welding bar or the length of a longitudinal welding bar of a pair of longitudinal welding bars is between 200 mm and 300 mm, preferably 250 mm. The longitudinal welding bar or pair of longitudinal welding bars is arranged in the apparatus so that it is perpendicular to the supply of the inner layers that are to be welded in the apparatus.

During welding of the outer layers 3 and 6, it is possible for the inner layers 4 and 5 to be kept apart from each other by at least one means, for example a separating lacquer or a mechanical separator such as an insulating strip of Teflon in order to prevent the two inner layers 4 and 5 from being welded together.

The apparatus also has means for providing a pattern repeat perforation line. The means for making a pattern repeat perforation line provide the welded layers 3, 4, 5, and 6 with at least one pattern repeat perforation line 2 according to FIG. 6, perpendicular to the longitudinal weld 8 of the inner layers 4 and 5.

In addition, the apparatus has a buffer equipped with a draw roller pair.

The apparatus also preferably has a winding unit. The winding unit preferably has a winder for winding the produced packs 1 onto a roll. After the production of the packs 1 shown in FIGS. 6 through 10, the packs 1 are preferably wound onto a takeup roll with the aid of the winder.

The method of making the packs 1 shown in FIGS. 6 through 10 will be described below.

In the illustrated embodiment according to FIG. 11, a single film layer is unwound from a supply roll in the production direction 14 with the aid of the unwinder in order to produce packs 1. A bidirectionally shrinkable plastic sheet is used for the film layer shown in FIG. 11.

In the illustrated embodiment, the inner layers 4 and 5 and the outer layers 3 and 6 are made from this single film layer. To accomplish this, the film layer is folded with the aid of a single triangular folder so that first, two layers 4, 5 lying one on top of the other are produced. The two layers 4, 5 are shown in FIG. 12. Then, the two folded layers 4, 5 are cut apart into two separate layers 4, 5, at the folded edge.

A part of the two layers 4, 5 constitutes, among other things, the subsequent outer layers 3 and 6.

Then the outer layers 3 and 6 are made from the two inner layers 4 and 5 by mechanical cutting or the like. After the outer layers 3 and 6, which are formed as strips, are cut from the part of the two layers 4, 5, there are then two inner layers 4 and 5 and four strips in the form of two outer layers 3 and two outer layers 6. According to FIG. 12, the outer layers 3 and 6 are consequently formed as strips. In this case, the layers 3, 4, 5, and 6 always move in the production direction 14 during manufacture of the packs.

Then, at least one detachment perforation line 11 is produced in—in particular punched into—the outer layers 3 and 6 that has not yet been welded parallel to the longitudinal weld 8 of the inner layers 4 and 5, by the means for making a detachment perforation line. According to FIG. 6, the detachment perforation line 11 is in the middle of the outer layers 3 and 6 formed as strips and extends through the layers 3, 6 in a straight line.

Alternatively and in a manner that is not used in the illustrated embodiment, the inner layers 4 and 5 can be produced from one film layer, in particular a folded and/or cut film layer, and the outer layers 3 and 6 can be produced from another film layer, in particular a folded and/or cut film layer.

Alternatively and in a manner that is not used in the illustrated embodiment, it is possible for the two inner layers 4 and 5 to be formed by a single film layer, in particular a folded and/or cut film layer, and for the outer layers 3 and 6 to each be produced from at least one separate layer. A separate layer of this kind that is rolled onto a roll is shown by way of example in FIG. 13.

For example, the layer shown in FIG. 13 forms one of the outer layers 3 of a pack 1. According to FIG. 13, the layer on the roll is coated with a reactive glue, preferably a hot melt. The reactive glue makes it possible for the outer layer 3 to be glued to the welded-together inner layers 4 and 5 so that the outer layer 3 is appropriately fastened to the inner layers 4 and 5. In this alternative embodiment, the same is true for the other inner layer 3 and the other outer layer 6 [sic]. Glued or glue-coated layers 3, 6 on separate rolls are not present in the illustrated embodiment.

In order to produce the packs 1 shown in FIGS. 6 through 10, in the illustrated embodiment, the two inner layers 4 and 5 of plastic film resting one on top of the other are then continuously welded in the production direction 14 with at least one longitudinal weld 8.

In the illustrated embodiment according to FIG. 14, the two inner layers 4 and 5 are continuously welded with four longitudinal welds 8. In this case, the two layers 4, 5 to be welded together in the illustrated embodiment are welded by pairs of longitudinal welding bars in a welding tower. Each longitudinal weld 8 in this case is welded by at least one pair of longitudinal welding bars.

Then, before each of the outer layers 3 and 6 is fastened to the respective inner layer 4, 5 at the two inner longitudinal welds 8 of the two inner layers 4 and 5 according to FIG. 15, the two welded-together inner layers 4 and 5 are cut in the production direction 14 so that these cut inner layers 4 and 5 each constitute a part of the inner layers 4 and 5. The inner layers 4 and 5 that are cut into three pieces are shown in FIG. 15.

Then, before the outer layers 3 and 6 are fastened to the respective inner layers 4 and 5, a lateral fold 30 is produced in each of the cut inner layers 4 and 5 according to FIG. 15, at the previously executed cut at the cut longitudinal welds 8. According to FIG. 6 and according to FIGS. 15 through 17, four lateral folds 30 are thus formed in the subsequently produced pack 1.

Then the two cut layers 4, 5—which are divided into three parts and have at least one lateral fold 30 at the cut longitudinal weld 8—are positioned relative to each other on the width B of the pack 1 to be produced, before the outer layers 3 and 6 are fastened to the respective inner layers 4 and 5. The positioning on the width B of the pack 1 to be produced is shown in FIG. 16.

Then, the cut inner layers 4 and 5 are each preopened before the outer layers 3 and 6 are fastened to the respective inner layers 4 and 5. The preopened layers 4, 5 are shown by way of example in FIG. 18.

In order to prevent the inner layers 4 and 5 from being welded while the outer layers 3 and 6 are being fastened to the respective inner layers 4 and 5, before the welding of the inner layers 4 and 5 in the illustrated embodiment, at least one means in the form of a mechanical separator—in the illustrated embodiment, a plurality of insulating strips of Teflon—are inserted between the two inner layers 4 and 5. Multiple insulating strips are thus inserted between the inner layers 4 and 5 before the two inner layers 4 and 5 are welded. The insulating strips are thus enclosed by the inner layers 4 and 5, with the inner layers 4 and 5 continuously sliding over the insulating strips. The insulating strips are not shown in FIGS. 6 through 18.

Alternatively and in a manner that is not carried out in the illustrated embodiment, it is possible for a separating lacquer to be used as the means; the inner face of the one inner layer 4 and/or the inner face of the second layer 5 can be or get coated with separating lacquer in at least one region in order to prevent welding.

Then, as the layers 3, 4, 5, and 6 are moving in the production direction 14, the outer layers 3 and 6—which are formed as strips and are moving at the same travel speed as the inner layers 4 and 5—are laid onto the positioned and welded-together inner layers 4 and 5 according to FIG. 17.

Then the two respective outer layers 3 formed as strips are laid onto the respective, separated inner layers 4 and the two outer layers 6 formed as strips are laid onto the respective, separated inner layers 5 according to FIG. 17. Consequently, at least one second outer layer 6 is also laid onto the welded-together inner layers 4 and 5, on the other side of the welded-together inner layers 4 and 5.

Before the outer layers 3 and 6 are welded to the respective inner layers 4 and 5, the outer layers 3 and 6 in the illustrated embodiment are positioned such that all of the outer layers 3 and 6 are already in position before the outer layer 3, 6 is fastened to the respective inner layer 4, 5.

Then, the outer layer 3, 6 is welded to the respective inner layer 4, 5 by at least one longitudinal weld 9 according to FIG. 6; the welded-together inner layers 4 and 5 are kept apart from each other with the aid of insulating strips. The insulating strips prevent a welding of the two inner layers 4 and 5. A welding also takes place, for example, in the welding tower of the apparatus that is not shown that in the illustrated embodiment is also equipped with a plurality of pairs of longitudinal welding bars for this purpose.

According to FIG. 6, the outer layers 3, which are each formed as a strip, are each continuously welded to the respective inner layers 4 by two longitudinal welds 9.

The outer layers 6, which are each formed as a strip, are also each continuously welded to the respective other inner layers 5 by two longitudinal welds 9.

Alternatively, it is possible for the respective layers 3, 4, 5, and 6 to be welded according to the above description in an exclusively stepped fashion or in a partially step-wise, partially continuous fashion. This is not the case, however, in the illustrated embodiment.

Then in the layers 3, 4, 5, and 6, perpendicular to the longitudinal weld 8 of the inner layers 4 and 5 according to FIG. 6, at least one pattern repeat perforation line 2 is provided in—in particular punched into—the layers 3, 4, 5, and 6 by the means for providing a pattern repeat perforation line. The pattern repeat perforation lines 2 in this case are provided in the layers 3, 4, 5, and 6 resting one on top of another and are spaced apart by the height H.

Then the layers 3, 4, 5, and 6 are supplied to the buffer by draw rollers. The purpose of the buffer is on the one hand to perform a corrective function. On the other hand, the buffer also performs a compensating function.

The corrective function lies in the fact that when the layers are wound onto the winder, the speed changes due to the changing diameter of the takeup roll. The buffer corrects this.

On the other hand, the winder has two arms for each takeup roll, thus enabling a continuous winding onto a respective one of the two takeup rolls. During the change from the one arm of the winder to the other arm of the winder, the buffer compensates for this winding procedure, which takes time. A change is necessary, for example, when the maximum winding diameter of the takeup roll is reached.

Then the packs 1 according to FIG. 6 are rolled onto a takeup roll of the winder in the apparatus.

In addition, and in a manner that is not shown in FIGS. 6 through 18, it is possible during production for at least one handle strip to be attached to each respective pack 1 or for at least one handle strip to be provided in—in particular punched into—the respective layers 3, 4, 5, and 6.

In addition, a respective part of the inner layer 4, 5 is or gets formed as a label 12 for the article; when the article is removed from the pack 1, the label 1 [12] remains on the article.

Furthermore, it is also possible for a perforation line or a precut for removal of a label 12 to be provided at the edge of the label 12 and for the labels 12 to be provided with a reactive glue on the side of the respective layer 4, 5 that is turned toward the article.

The labels 12 in this case are preferably each at a respective one of the compartments 7a, 7b, 7c.

During production of such labels 12, they are each provided in the layers 4, 5 before the longitudinal welds are produced.

According to the above, in the illustrated embodiment according to FIGS. 6 through 18, a handle strip is not provided and a part of the layers 4, 5 is not formed as a label 12.

In an appropriate apparatus, the packs 1 according to FIGS. 6 through 10 that are produced according to the above-described method can each be filled with an article, for example bottles 29.

A filled pack 1 according to the above description is shown by way of example in FIGS. 7 through 9.

1. A method of making packs from plastic film and each having at least one compartment for articles, the method comprising the steps of:
welding together two inner layers of plastic film resting one on top of the other together continuously or in steps with at least one longitudinal weld; then
placing at least one additional outer layer of plastic film against the two welded-together inner layers; and
bonding the outer layer continuously or in steps to the welded-together inner layers.

2. The method according to claim 1, wherein the outer layer is welded with at least one longitudinal weld to the welded-together inner layers, the method further comprising the step of:
separating the two welded-together inner layers apart from each other by at least one means in order to prevent welding-together of the two inner layers during bonding of the outer layer to the inner layers.

3. The method according to claim 2, wherein the separation of the two inner layers is done by a separating lacquer or an insulating strip.

4. The method according to claim 3, wherein the inner face of the one inner layer and/or the inner face of the second inner layer gets coated or is coated with the separating lacquer.

5. The method according to claim 3, wherein for separating the inner layers the insulating strip is inserted between the two inner layers before the two inner layers are welded.

6. The method according to claim 3, wherein the insulating strip is of Teflon.

7. The method according to claim 1, wherein the layers to be welded are welded by at least one longitudinal welding bar or by at least one pair of longitudinal welding bars.

8. The method according to claim 7, wherein the layers to be welded are welded by the longitudinal welding bar or the pair of longitudinal welding bars in a travel direction perpendicular to the supply direction of the inner layers that are to be welded.

9-27. (canceled)

28. An apparatus for making packs out of plastic film, having at least one compartment for articles the apparatus comprising:
means for welding together two inner layers of plastic film resting one on top of the other continuously or in steps with at least one longitudinal weld;
means for placing at least one additional outer layer of plastic film against the two welded-together inner layers; and
means for bonding the outer layer continuously or in steps to the welded-together inner layers.

29. The apparatus according to claim 28, wherein the means for welding has at least one longitudinal welding bar or at least one pair of longitudinal welding bars.

30. The apparatus according to claim 29, wherein the length of a longitudinal welding bar or the length of a pair of longitudinal welding bars is between 200 mm and 300 mm, preferably 250 mm.

31. The apparatus according to claim 29, wherein the longitudinal welding bar or pair of longitudinal welding bars is arranged in the apparatus perpendicular to the supply direction of the inner layers that are to be welded.

32. The apparatus according to claim 28, wherein the apparatus has at least one insulating strip of Teflon.

33. The apparatus according to claim 28, further comprising:
at least one supply roll for supplying at least one film layer.

34. The apparatus according to claim 28, further comprising:
at least one triangular folder.

35. The apparatus according to claim 28, further comprising:
a winder for winding the produced packs.

36. A pack for articles, wherein the pack is produced with the method according to claim 1.

37. The pack according to claim 36, in that wherein the pack is an outer packaging.

38. The pack according to claim claim 37, wherein the pack is wound onto a takeup roll.

39. A string of packs, wherein the string of packs has at least two packs made according to the method of claim 1.
